(19) United States
(12) Patent Application Publication
(10) Pub. No.: US 2025/0346790 A1
(43) Pub. Date: Nov. 13, 2025

(54) DOUBLE-FACED PRESSURE-SENSITIVE ADHESIVE SHEET

(71) Applicant: NITTO DENKO CORPORATION, Ibaraki-shi, Osaka (JP)

(72) Inventors: Hiroyasu ISHII, Ibaraki-shi, Osaka (JP); Toshihide SUZUKI, Ibaraki-shi, Osaka (JP); Ryui ASAI, Ibaraki-shi, Osaka (JP)

(73) Assignee: NITTO DENKO CORPORATION, Ibaraki-shi, Osaka (JP)

(21) Appl. No.: 18/871,293

(22) PCT Filed: Jun. 22, 2023
(86) PCT No.: PCT/JP2023/023071

§ 371 Date: Dec. 3, 2024

(30) Foreign Application Priority Data
Jun. 27, 2022 (JP) 2022-102832

(51) Int. Cl. C09J 7/38

(52) U.S. Cl. CPC C09J 7/385; C09J 2203/326; C09J 2433/00

(57) ABSTRACT

A thin double-faced PSA sheet capable of combining processability and impact resistance is provided. Provided is a double-faced PSA sheet having a first PSA layer, at least one middle layer, and a second PSA layer in this order. The double-faced PSA sheet has a total thickness of 60 μm or less. The middle layer has a thickness accounting for 10% to 60% of the total thickness, is formed from a water-dispersed material, and has a Young's modulus in the range of 1.5 MPa to 1500 MPa.

### TECHNICAL FIELD

The present invention relates to a double-faced pressure-sensitive adhesive sheet.

The present application claims priority to Japanese Patent Application No. 2022-102832 filed on Jun. 27, 2022 and the entire content thereof is herein incorporated by reference.

### BACKGROUND ART

In general, pressure-sensitive adhesive (PSA) exists as a soft solid (a viscoelastic material) in a room temperature range and has a property to adhere easily to adherend with some pressure applied. Because of such properties, PSA has been widely used as, for instance, a double-faced PSA sheet with substrate having PSA layers on a support substrate or a PSA sheet without substrate having no support substrate, for purposes such as bonding and fixing members in smartphones and other mobile electronics. Technical documents related to double-faced PSA tape with substrate include Patent Documents 1 to 5.

### CITATION LIST

### Patent Literature

[Patent Document 1] International Publication WO2018/101335
[Patent Document 2] Japanese Patent Application Publication No. 2000-248236
[Patent Document 3] Japanese Translation of PCT International Application No. 2009-536675
[Patent Document 4] Japanese Patent Application Publication No. 2017-105878
[Patent Document 5] Japanese Patent Application Publication No. 2006-63189

### SUMMARY OF INVENTION

### Technical Problem

In an adhesively double-faced PSA sheet, in order to obtain good processability, polyethylene terephthalate (PET) film is typically used as the support substrate. However, for PSA sheets with PET support substrate, due to the high elasticity of PET, the impact resistance and contour conformability tend to decrease. On the other hand, for PSA sheets used in portable electronic devices at risk of falling, impact resistance may be required depending on where they are applied. To obtain good impact resistance, it is preferable to use a so-called substrate-free PSA sheet that is free of a support substrate (PSA sheet without substrate). However, because a PSA sheet without substrate essentially consists of a viscoelastic PSA layer has a disadvantage in terms of processability when compared with a PSA sheet with substrate. For instance, PSA sheets used to secure components of portable electronic devices are processed to fit the shapes of the bonding/fixing areas by cutting processes such as punching. However, PSA sheets without substrate are more prone to problems during the processes than PSA sheets with substrate, such as the PSA sheet sticking to the blade during successive punching to disable punching of the next PSA sheet supplied.

As described above, to combine processability and impact resistance which are technically in a trade-off relationship, in one possible method, for instance, the PSA layer thickness is increased on each side of the PET support substrate to obtain the elastic modulus of the support substrate while taking advantage of the stress relaxation of the PSA layer. However, for instance, PSA sheets used in portable electronic devices tend to be made thinner due to the demand for smaller and lighter portable electronic devices, and there are limitations to the means of taking advantage of the PSA layer thickness. With thin PSA sheets, it is further difficult to realize both processability and impact resistance.

The present invention has been made in view of such circumstances with an objective to provide a thin double-faced PSA sheet that can bring about both processability and impact resistance.

### Solution to Problem

This description provides a double-faced PSA sheet having a first PSA layer, at least one middle layer, and a second PSA layer in this order. The double-faced PSA sheet has a total thickness of 60 μm or less. The middle layer thickness accounts for 10% to 60% of the total thickness. In addition, the middle layer is formed from a water-dispersed material. The middle layer has a Young's modulus in the range of 1.5 MPa to 1500 MPa. According to this embodiment, although the double-faced PSA sheet is thin with a total thickness of 60 μm or less, it can bring about both processability and impact resistance.

By using a water-dispersed material (specifically, a water dispersion of middle-layer-forming materials) as the middle-layer-forming material, it is possible to prevent or reduce migration of components that may occur at the interfaces with the PSA layers. The fact that there is little interlayer component migration means that the PSA sheet is less susceptible to property changes with aging caused by the component migration. In a thin PSA sheet with a total thickness of 60 μm or less as disclosed herein, even a little migration of components can have a large effect on various properties such as adhesive properties. Thus, it is of practical importance to prevent or reduce interlayer component migration.

In some preferable embodiments, at a temperature of 25° C. and at a frequency of 160 Hz, the middle layer has a storage modulus in the range of 7.0×10⁶ Pa to 5.0×10⁹ Pa. This frequency is thought to correspond to the speed range during punching. The use of a middle layer having such a 160 Hz storage modulus helps obtain good processability (specifically, ease of punching).

In some preferable embodiments, at a temperature of 25° C. and at a frequency of 1000 Hz to 10000 Hz, the middle layer has a storage modulus of 3.7×10⁹ Pa or lower. This frequency range is thought to correspond to the speed range of impact (e.g., drop impact such as the impact in the impact resistance test described later). The use of the middle layer having such a 10³-10⁴ Hz storage modulus helps obtain good impact resistance.

In some preferable embodiments, the middle layer includes a polyurethane-based resin, rubber, polyolefinic resin, acrylic resin, or a blend of these. According to an embodiment using such a material for the middle layer, processability and impact resistance can be preferably combined.

In some preferable embodiments, the first and second PSA layers are each formed from a water-dispersed PSA composition. With water-dispersed PSA compositions, due to the wettability to substrates (e.g., PET substrates), ingenuity and care are required for applying thin layers of PSA with high precision. In the art disclosed herein, it is possible to adopt a design that forms the first and second PSA layers from a water-dispersed PSA composition with focus on preventing interlayer component migration with aging.

In some preferable embodiments, each of the first and second PSA layers is an acrylic PSA layer comprising an acrylic polymer. The art disclosed herein is preferably implemented in an embodiment using acrylic PSA. In view of impact resistance, a preferable acrylic polymer has a glass transition temperature (Tg) of −25° C. or lower.

The double-faced PSA sheet according to some preferable embodiments has a 180° peel strength on stainless-steel plate (on-SUS peel strength) of 6 N/20 mm or greater. The double-faced PSA sheet with such an on-SUS peel strength is preferably used as a bonding/fixing means with highly-reliable adhesion in various applications.

The double-faced PSA sheet disclosed herein can combine processability and impact resistance despite of the thin body; and therefore, it is preferably used for bonding components of portable electronic devices having a tendency towards smaller and lighter builds as well as being required to have good processability and impact resistance. When the double-faced PSA sheet disclosed herein is processed (e.g., punched) into a prescribed shape (e.g., a band, frame, etc.) and then used to bond components of a portable electronic device, it can exhibit good impact resistance against dropping of the portable electronic device, etc. As described above, this description provides a portable electronic device that uses a double-faced PSA sheet disclosed herein, in other words, a portable electronic device comprising the PSA sheet.

### BRIEF DESCRIPTION OF DRAWINGS

FIG. 1 shows a schematic cross-sectional view illustrating a configuration of the PSA sheet according to an embodiment.

### DESCRIPTION OF EMBODIMENTS

Preferred embodiments of the present invention are described below. Matters necessary to practice this invention other than those specifically referred to in this description can be understood by a person skilled in the art based on the disclosure about implementing the invention in this description and common general knowledge at the time of application. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate size or reduction scale of an actual product provided.

The term “PSA” in this description refers to a material present in a soft solid (viscoelastic) state in a room temperature range and has a property to adhere to adherend with some pressure applied. As defined in “Adhesion: Fundamental and Practice” by C. A. Dahlquist (McLaren & Sons (1966), P. 143), the PSA referred to herein can be a material having a property that satisfies complex tensile modulus E* (1 Hz)<10⁷ dyne/cm² (typically, a material exhibiting the described characteristics at 25° C.).

As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

The term “acrylic polymer” in this description refers to a polymer comprising, as a monomeric unit constituting the polymer, more than 50 wt (% by weight) of a monomeric unit derived from an acrylic monomer. The acrylic monomer refers to a monomer having at least one (meth)acryloyl group per molecule.

The term “water-dispersed” in the present description refers to a state where components are at least partially dispersed in water. For instance, the term “water-dispersed PSA composition” refers to a composition comprising a PSA composition and water while being in a state where the PSA composition is at least partially dispersed in water. The water-dispersed state also includes a suspended state and an emulsified state.

### <Constitution of Double-Faced PSA Sheet>

The double-faced PSA sheet disclosed herein has a first PSA layer, a middle layer, and a second PSA layer in this order. The concept of a PSA sheet as used herein may encompass so-called PSA tape, PSA label and PSA film. The PSA layer is typically formed continuously, but is not limited to such a configuration. It may instead be formed in a regular or random pattern of dots, stripes, etc. The PSA sheet may be in a roll form or a flat sheet form. Alternatively, the PSA sheet may be in a form that has been fashioned into any of various other shapes.

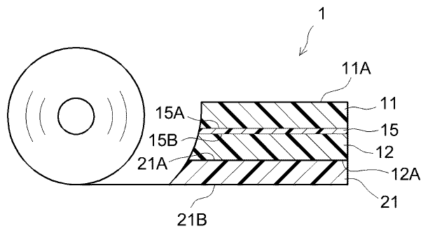

The PSA sheet disclosed herein may be, for instance, in a form of an adhesively double-faced PSA sheet having a cross-sectional structure schematically illustrated in FIG. 1. Double-faced PSA sheet 1 has a middle layer 15, first and second PSA layers 11 and 12 supported on the two faces of middle layer 15, respectively. More specifically, middle layer 15 has a first face 15A and a second face 15B (both non-releasable) provided with the first PSA layer 11 and second PSA layer 12, respectively. As shown in FIG. 1, double-faced PSA sheet 1 prior to use (before adhered to an adherend) may be in a form where it is layered with a release liner 21 having a front face 21A and a back face 21B both releasable and wound together in a roll. In double-faced PSA sheet 1 having such a form, the surface (second adhesive face 12A) of the second PSA layer 12 and the surface (first adhesive face 11A) of the first PSA layer 11 are protected with the front face 21A and back face 21B of release liner 21, respectively. Alternatively, it may be in a form where the first adhesive face 11A and second adhesive face 12A are protected with two separate release liners.

The total thickness of the double-faced PSA sheet disclosed herein (the thickness including the PSA layers and the middle layer, but not a release liner if any) is 60 μm or less. The double-faced PSA sheet with a limited thickness of 60 μm or less can effectively meet the demand for thinner and lighter products (e.g., portable electronic devices) to which it is applied. In some preferable embodiments, in view of thickness reduction, the double-faced PSA sheet has a total thickness of about 50 μm or less, possibly about 45 μm or less, about 40 μm or less, or about 35 μm or less (e.g., 32 μm or less). In other embodiments, the total thickness of the double-faced PSA sheet can be about 30 μm or less, about 25 μm or less, or even about 22 μm or less. According to the art disclosed herein, in an embodiment where the double-faced PSA sheet has a limited total thickness, by making the middle layer to have a thickness proportionally in a certain range, excellent impact resistance can be realized while obtaining good processability. The minimum total thickness of the double-faced PSA sheet is not particularly limited. For instance, it is possibly about 5 μm or greater, suitably about 10 μm or greater, preferably about 15 μm or greater, more preferably about 20 μm or greater, yet more preferably about 25 μm or greater, also possibly about 30 μm or greater, or even about 40 μm or greater. According to the art disclosed herein, in the double-faced PSA sheet having a total thickness in these ranges, processability and impact resistance can be combined at a high level.

### <First and Second PSA Layers>

### (Base Polymer)

In the art disclosed herein, the types of PSA constituting the first and second PSA layers are not particularly limited. The PSA layer may comprise, as adhesive polymer (or “base polymer” hereinafter), one, two or more species among various rubber-like polymers such as acrylic polymer, rubber-based polymer (natural rubber, synthetic rubber, a mixture of these, etc.), polyester-based polymer, urethane-based polymer, polyether-based polymer, silicone-based polymer, polyamide-based polymer, and fluoropolymer that can be used in the PSA field. From the standpoint of the adhesive properties, cost, etc., a preferable PSA comprises an acrylic polymer or a rubber-based polymer as the base polymer. In particular, an acrylic PSA (a PSA whose base polymer is an acrylic polymer) is preferable. The art disclosed herein can be preferably implemented in an embodiment using an acrylic PSA.

In the following, a PSA sheet having an acrylic PSA layer (i.e., a PSA layer formed of an acrylic PSA) is mainly described; however, the PSA layer in the PSA sheet disclosed herein is not to be limited to those formed of acrylic PSA.

The “base polymer” of a PSA refers to a rubber-like polymer in the PSA. Besides this, it is not limited to a particular interpretation. The rubber-like polymer refers to a polymer that shows rubber elasticity around room temperature. As used herein, the “main component” (primary component) refers to a component accounting for more than 50 wt %.

### (Acrylic Polymer)

In some preferable embodiments, the PSA layer (the term used to encompass the first and second PSA layers; the same applies hereinafter unless otherwise informed) includes an acrylic polymer as the base polymer.

As the acrylic polymer, for example, a polymer of a monomeric starting material (monomers) comprising an alkyl (meth)acrylate as the primary monomer and possibly comprising a secondary monomer copolymerizable with the primary monomer is preferable. The primary monomer herein refers to a component that accounts for higher than 50 wt % of the monomer composition in the monomeric starting material.

As the alkyl (meth)acrylate, for instance, a compound represented by the following formula (1) can be preferably used:

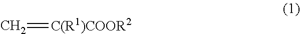

Herein, R¹ in the formula (1) is a hydrogen atom or a methyl group. R² is a linear alkyl group having 1 to 20 carbon atoms (hereinafter, such a range of the number of carbon atoms may be indicated as “C₁₋₂₀”). From the standpoint of the storage elastic modulus of PSA, an alkyl (meth)acrylate with R² being a C₁₋₁₄ linear alkyl group is preferable, an alkyl (meth)acrylate with R² being a C₁₋₁₀ linear alkyl group is more preferable, and an alkyl (meth)acrylate with R² being a butyl group or a 2-ethylhexyl group is particularly preferable.

Examples of an alkyl (meth)acrylate with R² being a C₁₋₂₀ linear alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, etc. Among these alkyl (meth)acrylates, can be used one species solely or a combination of two or more species. Preferable alkyl (meth)acrylates include n-butyl acrylate (BA) and 2-ethylhexyl acrylate (2EHA).

The art disclosed herein can be preferably implemented in an embodiment where the monomers comprise an alkyl (meth)acrylate wherein R² in the formula (1) is a C₄₋₁₀ acyclic alkyl group (or “C₄₋₁₀ acyclic alkyl (meth)acrylate”; typically at least either BA or 2EHA) and the total amount of the C₄₋₁₀ acyclic alkyl (meth)acrylate (typically the total amount of BA and 2EHA) accounts for 70 wt % or more (typically 80 wt % or more) of the alkyl (meth)acrylate(s) in the monomers. In the embodiment using the C₄₋₁₀ acyclic alkyl (meth)acrylate, the amount of 2EHA is not particularly limited. It is suitably more than 50 wt % of the C₄₋₁₀ acyclic alkyl (meth)acrylate. In view of impact resistance, it is preferably 70 wt % or more, more preferably 90 wt % or more, or yet more preferably 95 wt % or more (e.g., 95 wt % to 100 wt %).

When the alkyl (meth)acrylate comprises an alkyl (meth)acrylate having an acyclic C₄₋₁₀ alkyl group as R² in the formula (1) (typically at least either BA or 2EHA), the total amount of the other alkyl (meth)acrylate(s) (alkyl (meth)acrylate(s) having an acyclic C_{<4} or C_{>10} alkyl group (alkyl group with fewer than four carbon atoms or more than ten carbon atoms) as R² in the formula (1)) is preferably about 30 wt % or less (e.g., 20 wt % or less, typically 15 wt % or less) of the monomers constituting the acrylic polymer. From the standpoint of obtaining the effects of the other alkyl (meth)acrylate(s), their total amount is preferably about 1 wt % or more (e.g., 5 wt % or more, typically 10 wt % or more) of the monomers. As the other alkyl (meth)acrylate, an alkyl (meth)acrylate having an acyclic C₁₋₃ alkyl group as R² in the formula (1) can be preferably used. Specific examples thereof include methyl acrylate (MA), methyl methacrylate (MMA) and ethyl acrylate (EA). Among them, MA is more preferable.

The secondary monomer copolymerizable with the alkyl (meth)acrylate being the primary monomer may be useful for introducing crosslinking points in the acrylic polymer or increasing the cohesive strength of the acrylic polymer. As the secondary monomer, for instance, the following functional group-containing monomers can be used one species solely or a combination of two or more species:

Carboxy group-containing monomers: for example, ethylenic unsaturated mono-carboxylic acids such as acrylic acid (AA), methacrylic acid (MAA), crotonic acid, etc.; ethylenic unsaturated dicarboxylic acids such as maleic acid, itaconic acid, citraconic acid, etc., as well as anhydrides thereof (maleic acid anhydride, itaconic acid anhydride, etc.).

Hydroxy group-containing monomers: for example, hydroxyalkyl (meth)acrylates such as 2-hydroxyethyl (meth)acrylate, 2-hydroxypropyl (meth)acrylate, 3-hydroxypropyl (meth)acrylate, 4-hydroxybutyl (meth)acrylate, etc.; unsaturated alcohols such as vinyl alcohol, allyl alcohol, etc.

Amide group-containing monomers: for example, (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide.

Amino group-containing monomers: for example, aminoethyl (meth)acrylate, N,N-dimethylaminoethyl (meth)acrylate, t-butylaminoethyl (meth)acrylate.

Epoxy group-containing monomers: for example, glycidyl (meth)acrylate, methylglycidyl (meth)acrylate, allyl glycidyl ether.

Cyano group-containing monomers: for example, acrylonitrile, methacrylonitrile.

Keto group-containing monomers: for example, diacetone (meth)acrylamide, diacetone (meth)acrylate, vinyl methyl ketone, vinyl ethyl ketone, allyl acetoacetate, vinyl acetoacetate.

Monomers having nitrogen atom-containing rings: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloyl morpholine.

Alkoxysilyl group-containing monomers: for example, 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane.

The functional group-containing monomers can be used singly as one species or in a combination of two or more species. Among the functional group-containing monomers, for the abilities to preferably bring about introduction of crosslinking points as described above and an increase in cohesive strength, carboxy group-containing monomers, hydroxy group-containing monomers and cyano group-containing monomers are preferable, with carboxy group-containing monomers being more preferable. Among carboxy group-containing monomers, AA and MAA are preferable.

In some preferable embodiments, as the functional group-containing monomer, AA and MAA are used together. The PSA composition comprising an acrylic polymer having such a monomer composition (i.e. copolymer composition) may produce a PSA sheet of higher performance (e.g., with greater repulsion resistance). The weight ratio of AA to MAA (AA/MAA) can be, for instance, in the range of 0.1 to 10. It is more preferably about 0.3 or higher, yet more preferably 0.5 or higher, or particularly preferably 1.0 or higher (e.g., above 1.0). It is more preferably about 5 or lower (typically 4 or lower). When AA/MAA is within these ranges, a sufficient effect to increase the repulsion resistance tends to be likely obtained and also after the PSA sheet is fabricated, it tends to have excellent temporal stability with respect to the adhesive properties.

In the acrylic polymer, an alkoxysilyl group-containing monomer is preferably copolymerized. The alkoxysilyl group-containing monomer is an ethylenic unsaturated monomer having at least one (preferably two or more, e.g., two or three) alkoxysilyl group per molecule. Specific examples thereof are as mentioned earlier. For the alkoxysilyl group-containing monomer, solely one species or a combination of two or more species can be used. By copolymerizing the alkoxysilyl group-containing monomer, upon the condensation reaction of the silanol group (silanol condensation), a crosslinked structure can be introduced in the PSA formed from the PSA composition comprising the acrylic polymer.

When a functional group-containing monomer is copolymerized in the acrylic polymer, the amount of functional group-containing monomer in all monomers constituting the acrylic polymer is not particularly limited. Usually, from the standpoint of combining cohesive strength and adhesiveness at a good balance, the amount of functional group-containing monomer is preferably about 0.1 by weight or higher (e.g., 0.5 wt % or higher, typically 1 wt % or higher). In view of the effect of the alkyl (meth)acrylate on the adhesion, the amount is preferably about 40 wt % or lower (e.g., 30 wt % or lower, typically 20 wt % or lower).

When a carboxy group-containing monomer is copolymerized in the acrylic polymer, in view of adhesive properties such as adhesive strength, the amount of carboxy group-containing monomers in all monomers is suitably 15 wt % or less, for instance, possibly 10 wt % or less. In some preferable embodiments, in view of impact resistance, the amount of carboxy group-containing monomers in all monomers is 5 wt % or less, or possibly 3 wt % or less. On the other hand, in view of cohesion, etc., in some embodiments, it can be, for instance, 0.1 wt % or greater, or even 0.5 wt % or greater. The art disclosed herein can be preferably implemented in an embodiment where the amount of carboxyl group-containing monomers in all monomers is 1 wt % or greater, or an embodiment where it is 1.5 wt % or greater.

When an alkoxysilyl group-containing monomer is copolymerized in the acrylic polymer, the amount of alkoxysilyl group-containing monomers is suitably 0.005 wt % or higher (e.g., 0.01 wt % or higher) of all the monomers. This amount is suitably about 0.1 wt % or lower (e.g., 0.03 wt % or lower).

For the purpose of increasing the cohesive strength of the acrylic polymer, etc., other co-monomer(s) besides the aforementioned secondary monomers can be used. Examples of such co-monomers include vinyl ester-based monomers such as vinyl acetate, vinyl propionate, etc.; aromatic vinyl compounds such as styrene, substituted styrenes (α-methylstyrene, etc.), vinyl toluene, etc.; cycloalkyl (meth)acrylates such as cyclohexyl (meth)acrylate, cyclopentyl (meth)acrylate, isobornyl (meth)acrylate, etc.; aromatic ring-containing (meth)acrylates such as aryl (meth)acrylate (e.g., phenyl (meth)acrylate), aryloxyalkyl (meth)acrylate (e.g., phenoxyethyl (meth)acrylate), arylalkyl (meth)acrylate (e.g., benzyl (meth)acrylate), etc.; olefinic monomers such as ethylene, propylene, isoprene, butadiene, isobutylene, etc.; chlorine-containing monomers such as vinyl chloride, vinylidene chloride, etc.; isocyanate group-containing monomers such as 2-(meth)acryloyloxyethyl isocyanate, etc.; alkoxy group-containing monomers such as methoxyethyl (meth)acrylate, ethoxyethyl (meth)acrylate, etc.; vinyl ether-based monomers such as methyl vinyl ether, ethyl vinyl ether, etc.; and the like.

Other examples of the other co-monomers excluding the secondary monomer include monomers having a plurality of functional groups in a molecule. Illustrative examples of such polyfunctional monomers include 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, glycerol di(meth)acrylate, epoxy acrylate, polyester acrylate, urethane acrylate, divinylbenzene, butyl di(meth)acrylate and hexyl di(meth)acrylate.

The amount of the other co-monomer(s) excluding the secondary monomer can be suitably selected according to the purpose and intended use, and thus is not particularly limited. For instance, of the monomer composition of the acrylic polymer, it is preferably 10 wt % or less, possibly 3 wt % or less, or even below 1 wt % (e.g., 0 wt % or greater and less than 1 wt %).

The acrylic polymer in the art disclosed herein is suitably designed to have a glass transition temperature (Tg) of −25° C. or below (typically −75° C. or above, but −25° C. or below). The acrylic polymer's Tg can be preferably −40° C. or below (e.g., −70° C. or above, but −40° C. or below) or more preferably −50° C. or below (typically −70° C. or above, but −50° C. or below). The use of an acrylic polymer with a low Tg tends to increase the impact resistance. The acrylic polymer's Tg is preferably at or below the upper limits from the standpoint of increasing the adhesive strength and the adhesion to the middle layer. The Tg of the acrylic polymer can be adjusted by the types and relative amounts of monomers used for synthesis of the polymer.

Herein, the Tg of an acrylic polymer refers to the value determined by the Fox equation based on the composition of the monomers. As shown below, the Fox equation is a relational expression between the Tg of a copolymer and glass transition temperatures Tgi of homopolymers of the respective monomers constituting the copolymer.

$$1 / Tg = \sum ( Wi / Tgi )$$

In the Fox equation, Tg represents the glass transition temperature (unit:K) of the copolymer, Wi represents the weight fraction (copolymerization ratio by weight) of a monomer i in the copolymer, and Tgi represents the glass transition temperature (unit:K) of homopolymer of the monomer i.

As the glass transition temperatures of homopolymers used for determining the Tg value, values found in publicly known documents are used. For example, with respect to the monomers listed below, as the glass transition temperatures of homopolymers of the monomers, the following values are used:

| | | |
|---|---|---|
| 2-ethylhexyl acrylate | −70° | C. |
| n-butyl acrylate | −55° | C. |
| methyl methacrylate | 105° | C. |
| methyl acrylate | 8° | C. |
| vinyl acetate | 32° | C. |
| acrylic acid | 106° | C. |
| methacrylic acid | 228° | C. |

With respect to the glass transition temperatures of homopolymers of monomers other than those listed above, values given in “Polymer Handbook” (3rd edition, John Wiley & Sons, Inc., Year 1989) are used. When the literature provides two or more values, the highest value is used.

With respect to monomers for whose homopolymers no glass transitions temperatures are given in Polymer Handbook, either, values obtained by the following measurement method are used (see Japanese Patent Application Publication No. 2007-51271). In particular, to a reaction vessel equipped with a thermometer, a stirrer, a nitrogen inlet and a condenser, are added 100 parts by weight of monomer, 0.2 part by weight of azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by mass solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and while applying a shear strain at a frequency of 1 Hz using a rheometer (ARES, available from Rheometrics Scientific, Inc.), the viscoelasticity is measured in the shear mode over a temperature range of −70° C. to 150° C. at a heating rate of 5° C./min; and the temperature value at the maximum of the tan 6 curve is taken as the Tg of the homopolymer.

The method for obtaining the acrylic polymer is not particularly limited. Various polymerization methods known as synthetic means for acrylic polymers can be suitably employed, such as a solution polymerization method, emulsion polymerization method, bulk polymerization method, suspension polymerization method, photopolymerization method, etc. As for preferable polymerization methods, the emulsion polymerization method is cited. The embodiment of emulsion polymerization is not particularly limited. Various monomer supply methods, polymerization conditions, materials and the like similar to those for heretofore known general emulsion polymerization can be suitably used to carry out polymerization. Examples of suitable monomer supply methods include an all-at-once supply method where all starting monomers are supplied at once, continuous (dropwise) supply method, portionwise (dropwise) supply method, etc. Starting monomers can be added dropwise as an aqueous emulsion. The polymerization temperature can be about 20° C. or higher (usually 40° C. or higher) while it is suitably about 100° C. or lower (usually 80° C. or lower).

According to the emulsion polymerization, a polymerization mixture can be prepared as an emulsion of acrylic polymer dispersed in water (acrylic polymer emulsion). For instance, the water-dispersed PSA composition may be preferably produced using the polymerization mixture or such a polymerization mixture upon suitable work-up. Alternatively, an acrylic polymer emulsion may be prepared by a polymerization method other than emulsion polymerization (e.g., solution polymerization, photopolymerization, bulk polymerization, etc.) to synthesize an acrylic polymer, then dispersing the polymer in water. In general, the use of an acrylic polymer emulsion designed to have a relatively high molecular weight tends to help obtain good processability.

The initiator used for the polymerization can be suitably selected in accordance with the type of polymerization method among heretofore known polymerization initiators. Examples include, but not limited to, azo-based initiators such as 2,2′-azobisisobutyronitrile, 2,2′-azobis(2-methylpropionamidine) disulfate salt, 2,2′-azobis(2-methylpropionamidine) dihydrochloride salt, 2,2′-azobis(2-amidinopropane) dihydrochloride salt, 2,2′-azobis[N-(2-carboxyethyl)-2-methylpropionamidine]hydrate, 2,2′-azobis(N,N′-dimethylene isobutylamidine), 2,2′-azobis[2-(2-imidazolin-2-yl)propane]dihydrochloride salt, etc.; persulfate salt-based initiators such as potassium persulfate, ammonium persulfate, etc.; peroxide-based initiators such as benzoyl peroxide, t-butyl hydroperoxide, hydrogen peroxide, etc.; substituted ethane-based initiators such as phenyl-substituted ethane, etc.; carbonyl-based initiators such as aromatic carbonyl compounds, etc.; redox-based initiators such as a combination of a persulfate salt and sodium hydrogen sulfite, a combination of a peroxide and sodium ascorbate, etc.; and so on. These polymerization initiators can be used singly as one species or in a combination of two or more species.

The polymerization initiator can be used in a usual amount and is not particularly limited. For instance, it can be selected from a range of about 0.005 by weight or above (preferably 0.01 part by weight or above) and of 1 part by weight or below (preferably 0.8 part by weight or below) relative to 100 parts by weight of all monomers.

In the polymerization, a chain transfer agent (which may also be thought as a molecular weight modifier or a regulator of polymerization degree) may be used as necessary. Examples of the chain transfer agent include mercaptans such as dodecyl mercaptan (dodecanethiol), lauryl mercaptan, glycidyl mercaptan, 2-mercaptoethanol, mercaptoacetic acid, 2-ethylhexyl thioglycolate and 2,3-dimethylcapto-1-propanol; α-methyl styrene dimer; and the like. Such chain transfer agents may be used singly or as a combination of two or more species.

To 100 parts by weight of the monomers, the chain transfer agent can be used in an amount of about 0.001 part by weight or greater (typically about 0.005 part by weight or greater, e.g., about 0.001 part by weight or greater), and, for instance, about 5 parts by weight or less (typically about 2 parts by weight or less, e.g., about 1 part by weight or less). By using a suitable amount of the chain transfer agent, a desirable conversion to polymer can be obtained.

Emulsion polymerization of the starting monomers is typically carried out in the presence of a surfactant (emulsifier). The amount of surfactant used is not particularly limited. In view of the polymerization stability and dispersion stability of the polymerization reactants, the amount of surfactant used is typically suitably 0.1 part by weight or greater, or preferably 0.5 part by weight or greater relative to 100 parts by weight of the starting monomers. From the standpoint of obtaining higher stability, it can be 1.0 part by weight or greater, or even 1.5 parts by weight or greater. The surfactant can be used in an amount of, for instance, 10 parts by weight or less relative to 100 parts by weight of the starting monomers. On the other hand, in view of adhesive properties, it is desirable to reduce the usage of surfactant (especially non-reactive surfactant). From such a standpoint, the amount of surfactant used is typically preferably 5 parts by weight or less, possibly 4 parts by weight or less, 3 parts by weight or less, or even 2.5 parts by weight or less.

As the surfactant, commonly known anionic surfactants, nonionic surfactants, cationic surfactants and the like can be used. Typically, an anionic or nonionic surfactant is preferable. A surfactant having a reactive functional group (in typical, a radically-polymerizable functional group) can also be used. Hereinafter, a surfactant having a reactive functional group may be referred to as a reactive surfactant while a general surfactant free of a reactive functional group may be referred to as a non-reactive surfactant. For the surfactant, solely one species or a combination of two or more species can be used.

Examples of non-reactive anionic surfactants include alkyl sulfates such as lauryl sulfate and octadecyl sulfate; fatty acid salts; alkyl benzene sulfonates such as nonyl benzene sulfonate and dodecyl benzene sulfonate; naphthalene sulfonates such as dodecylnaphthalene sulfonate; alkyl diphenyl ether disulfonate such as dodecyl diphenyl ether disulfonate; polyoxyethylene alkyl ether sulfates such as polyoxyethylene octadecyl ether sulfate and polyoxyethylene lauryl ether sulfate; polyoxyethylene alkyl phenyl ether sulfates such as polyoxyehtylene lauryl phenyl ether sulfate; polyoxyethylene styrenated phenyl ether sulfate; sulfosuccinates such as lauryl sulfosuccinate and polyoxyethylene lauryl sulfosuccinate; polyoxyethylene alkyl ether phosphates; and polyoxyethylene alkyl ether acetates. When the anionic surfactant is in a salt form, the salt can be, for instance, a metal salt (preferably a monovalent metal salt) such as a sodium salt, potassium salt, calcium salt and magnesium salt; ammonium salt; or amine salt.

Examples of non-reactive nonionic surfactants include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan fatty acid esters such as sorbitan monolaurate, sorbitan monostearate and polyoxyethylene sorbitan monolaurate; polyoxyethylene glyceryl ether fatty acid esters; and polyoxyethylene-polyoxypropylene block copolymers.

As the reactive surfactant, it is preferable to use a species having a polymerizable (in typical, radically-polymerizable) functional group. For instance, it is possible to use a reactive surfactant having a structure of an aforementioned anionic or nonionic surfactant with an introduced radically-polymerizable functional group. The type of radically-polymerizable functional group is not particularly limited. It can be, for instance, an alkenyl group, acryloyl group, methacryloyl group, vinyl group, vinyl ether group (vinyloxy group), allyl ether group (allyloxy group), etc. Specific examples of the alkenyl group include propenyl group and isopropenyl group (CH₂═C(CH₃)—). The concept of propenyl group referred to herein encompasses 1-propenyl group (CH₃—CH═CH—) and 2-propenyl group (CH₂═CH—CH₂— which may be called allyl group).

Examples of anionic reactive surfactants include polyoxyethylene (allyloxymethyl) alkyl ether sulfates (e.g., ammonium salts), polyoxyethylene nonyl propenyl phenyl ether sulfates (e.g., ammonium salts), alkyl allyl sulfosuccinates (e.g., sodium salts), methacryloxy polyoxypropylene sulfuric acid ester salts (e.g., sodium salts), and polyoxyalkylene alkenyl ether sulfates (e.g., an ammonium salt having an isopropenyl group as the terminal alkenyl group). When the anionic reactive surfactant is forming a salt, the salt can be, for instance, a metal salt such as sodium salt or a non-metal salt such as ammonium salt and amine salt.

An example of nonionic reactive surfactants is polyoxyethylene nonyl propenyl phenyl ether.

Commercially available reactive surfactants include trade names AQUALON HS-05, AQUALON HS-10, AQUALON HS-1025, AQUALON HS-20, AQUALON KH-10, AQUALON KH-1025, AQUALON KH-05, AQUALON BC-0515, AQUALON BC-10, AQUALON BC-1025, AQUALON BC-20, AQUALON BC-2020, AQUALON RN-20, AQUALON RN-30, AQUALON RN-50, AQUALONAR-10, AQUALONAR-20AQUALONAR-1025 andAQUALONAR-2020 available from Dai-ichi Kogyo Seiyaku Co., Ltd.; trade names ADEKA REASOAP SE-10N and ADEKAREASOAP SR-1025 available from ADEKA Corporation; trade names LATEMULE PD-104, LATEMULE PD-420, LATEMULE PD-430 and LATEMULE PD-450 available from Kao Corporation; trade names ELEMINOL JS-20 and ELEMINOL RS-3000 available from Sanyo Chemical Industries, Ltd; and trade name ANTOX MS-60 available from Nippon Nyukazai Co., Ltd.

From the standpoint of the emulsification properties, etc., in some embodiments, an anionic reactive surfactant can be preferably used.

When using a nonionic reactive surfactant, more favorable results can be obtained when used in combination with other surfactant(s), for instance, an anionic reactive surfactant, anionic non-reactive surfactant, nonionic non-reactive surfactant, etc.

In embodiments using a surfactant, in view of adhesive properties, the surfactant preferably comprises a reactive surfactant. In other words, at least one of the surfactants used is preferably a reactive surfactant. By carrying out emulsion polymerization of the starting monomers in the presence of a reactive surfactant, the reactive surfactant may undergo a reaction to be incorporated in the acrylic polymer. Upon incorporation in the acrylic polymer, the surfactant in its free form will decrease in amount (the amount of free surfactant molecules will decrease). The reactive surfactant molecules incorporated in the acrylic polymer have limited mobility within the PSA layer, making them less likely to bleed out to the PSA layer surface. Thus, when carrying out the polymerization, the use of reactive surfactant can be advantageous for combining polymerization stability and adhesive properties of the PSA layer obtained from the post-polymerization, acrylic polymer-containing PSA composition. From the standpoint of obtaining superior adhesive properties, the amount of reactive surfactant in the total weight of surfactant used in the emulsion polymerization can be 50 wt % or higher, or more preferably 70 wt % or higher. For instance, it may be preferable to employ an embodiment using solely a reactive surfactant as the surfactant. It is noted that, in this Description, the concept of “including a reactive surfactant” encompasses “including the reactive surfactant with its reactive functional group (e.g., radically-polymerizable functional group) in a reacted form”. Of the reactive surfactant in the art disclosed herein, at least some molecules are typically incorporated in the acrylic polymer as described above when included in a water-dispersed PSA composition or a PSA layer.

The weight average molecular weight (Mw) of the acrylic polymer is not particularly limited. For instance, it can be in a range of 10×10⁴ to 500×10⁴. Herein the Mw of the acrylic polymer refers to a Mw of a toluene-soluble material (a sol component) of the acrylic polymer. The Mw of the acrylic polymer refers to the value based on standard polystyrene determined by GPC (gel permeation chromatography). From the standpoint of increasing the adhesive properties, the acrylic polymer may have a Mw of preferably 150×10⁴ or smaller, or more preferably 100×10⁴ or smaller. From the standpoint of the cohesion, etc., the acrylic polymer may have a Mw of preferably 20×10⁴ or larger, or more preferably 30×10⁴ or larger (e.g., 40×10⁴ or larger). A higher Mw tends to help obtain good processability.

### (Tackifier Resin)

In some preferable embodiments, the PSA layer comprises a tackifier resin. This helps obtain a PSA sheet having excellent adhesive properties (e.g., adhesive strength, repulsion resistance). Examples of the tackifier resin include rosin-based tackifier resins (including rosin derivative tackifier resins), petroleum-based tackifier resins, terpene-based tackifier resins, phenolic tackifier resins and ketone-based tackifier resins. These can be used solely as one species or in a combination of two or more species.

Examples of the rosin-based tackifier resin include rosins such as gum rosin, wood rosin and tall oil rosin as well as stabilized rosins (e.g., stabilized rosins obtained by disproportionation or hydrogenation of the rosins), polymerized rosins (e.g., multimers, typically dimers, of the rosins) and modified rosins (e.g., unsaturated acid-modified rosins obtained by modification with an unsaturated acid such as maleic acid, fumaric acid or (meth)acrylic acid).

Examples of the rosin derivative tackifier resin include esterification products of the rosin-based resins (e.g., rosin esters such as stabilized rosin esters and polymerized rosin esters), phenol modification products of the rosin-based resins (phenol-modified rosins) and their esterification products (phenol-modified rosin esters).

Examples of the petroleum-based tackifier resin include aliphatic petroleum resins, aromatic petroleum resins, copolymeric petroleum resins, alicyclic petroleum resins and their hydrogenation products.

Examples of the terpene-based tackifier resin include α-pinene resins, β-pinene resins, aromatic group-modified terpene-based resins, and terpene-phenolic resins.

Examples of the ketone-based tackifier resin include ketone-based resins resulting from condensation of ketones (e.g., aliphatic ketones such as methyl ethyl ketone, methyl isobutyl ketone, acetophenone, etc.; alicyclic ketones such as cyclohexanone, methyl cyclohexanone, etc.) with formaldehyde.

Examples of the tackifier resin that can be preferably used in the art disclosed herein include rosin-based tackifier resins and terpene-based tackifier resins. Preferable examples of rosin-based tackifier resins include stabilized rosin esters and polymerized rosin esters. Preferable examples of terpene-based tackifier resins include terpene-phenol-based resins.

The softening point (Ts) of the tackifier resin used is not particularly limited. From the standpoint of enhancing the cohesion, etc., the tackifier resin's Ts is, for instance, possibly 80° C. or higher, preferably 90° C. or higher, also possibly 100° C. or higher, 120° C. or higher, or even 130° C. or higher.

While no particular limitations are imposed, in some embodiments, the tackifier resin may comprise a high-Ts tackifier resin having a Ts of 140° C. or higher. The high-Ts tackifier resin has a Ts of preferably 145° C. or higher, for instance, possibly 150° C. or higher, 155° C. or higher, 160° C. or higher, or even 165° C. or higher. The use of high-Ts tackifier resin can favorably combine adhesion and cohesion. The maximum Ts of the tackifier resin is not particularly limited. From the standpoint of the compatibility, low-temperature properties, etc., it is usually suitably 200° C. or lower, preferably 180° C. or lower, or possibly 175° C. or lower.

The softening point of a tackifier resin as referred to herein is defined as a value measured based on the softening point test method (ring and ball method) specified in both JIS K5902 and JIS K2207. In particular, a sample is quickly melted at a lowest possible temperature, and with caution to avoid bubble formation, the melted sample is poured into a ring to the top, with the ring being placed on top of a flat metal plate. After cooled, any portion of the sample risen above the plane including the upper rim of the ring is sliced off with a small knife that has been somewhat heated. Following this, a support (ring support) is placed in a glass container (heating bath) having a diameter of 85 mm or larger and a height of 127 mm or larger, and glycerin is poured into this to a depth of 90 mm or deeper. Then, a steel ball (9.5 mm diameter, weighing 3.5 g) and the ring filled with the sample are immersed in the glycerin while preventing them from making contact. The temperature of glycerin is maintained at 20° C.±5° C. for 15 minutes. The steel ball is then placed at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated evenly by projecting a Bunsen burner flame at the midpoint between the center and the rim of the bottom of the container. After the temperature has reached 40° C. from the start of heating, the rate of the bath temperature rise must be kept at 5.0° C.±0.5° C. per minute. As the sample gradually softens, the temperature at which the sample flows out of the ring and finally touches the bottom plate is read as the softening point. Two or more measurements of softening point are performed at the same time, and their average value is used.

In an embodiment where the PSA layer is formed from a water-dispersed PSA composition, as the tackifier resin, it is preferable to use a water-dispersed tackifier resin (also called tackifier resin emulsion). In such embodiments, the water-dispersed PSA composition comprises a tackifier resin as an emulsion of the tackifier resin dispersed in water. For instance, by mixing an aqueous emulsion of an acrylic polymer and an emulsion of the tackifier resin, a PSA composition can be easily prepared, comprising these components at a desirable ratio. A preferable tackifier resin emulsion is essentially free of at least aromatic hydrocarbon-based solvents (more preferably essentially free of aromatic hydrocarbon-based solvents and other organic solvents).

Such a tackifier resin emulsion can be prepared, using a surfactant (emulsifier) as necessary. As the surfactant possibly used in preparation of the tackifier resin emulsion, one, two or more species can be suitably selected and used among the same kinds of surfactant usable in preparation of the acrylic polymer emulsion. In typical, an anionic surfactant or nonionic surfactant is preferably used. The surfactant used for preparing the tackifier resin emulsion can be the same as or different from the surfactant used for preparing the acrylic polymer emulsion. For instance, it is preferable to employ an embodiment using an anionic surfactant in each emulsion preparation, an embodiment using a nonionic surfactant in each emulsion preparation, an embodiment using an anionic surfactant in one and a nonionic surfactant in the other, etc. The amount of surfactant used is not particularly limited as long as the tackifier resin can be prepared as an emulsion. For instance, it can be about 0.2 part by weight or greater (preferably 0.5 part by weight or greater) and about 10 parts by weight or less (preferably 5 parts by weight or less) to 100 parts by weight of tackifier resin (non-volatiles).

From the standpoint of obtaining preferable effects of the use, usually, the amount (based on non-volatiles) of tackifier resin used is, to 100 parts by weight of base polymer (e.g., acrylic polymer), suitably 1 part by weight or greater, preferably 3 parts by weight or greater (e.g., 5 parts by weight or greater), more preferably 12 parts by weight or greater, or yet more preferably 16 parts by weight or greater. According to the art disclosed herein, good adhesive properties can be obtained in an embodiment comprising 22 parts or more (e.g., 25 parts or more) by weight of tackifier resin to 100 parts by weight of base polymer. From the standpoint of the cohesive strength, etc., usually, the amount of tackifier resin used is, to 100 parts by weight of base polymer, suitably 90 parts by weight or less, preferably 70 parts by weight or less, more preferably 55 parts by weight or less, yet more preferably 50 parts by weight or less (e.g., 45 parts by weight or less, typically 40 parts by weight or less).

When the PSA layer comprises a high-Ts tackifier resin, from the standpoint of the cohesive strength, etc., the high-Ts tackifier resin can be used alone as the tackifier resin. From the standpoint of balancing with various other adhesive properties, in some embodiments, a high-Ts tackifier resin can be used in combination with a tackifier resin having a lower Ts (e.g., a tackifier resin with Ts≤120° C. or Ts≤110° C.). In such an embodiment, the amount of high-Ts tackifier resin in the entire tackifier resin used can be, for instance, 20 wt % or higher, 40 wt % or higher, or even 60 wt % or higher. The amount of high-Ts tackifier resin can be, for instance, 90 wt % or lower, 80 wt % or lower, or even 70 wt % or lower. In view of impact resistance, it can be advantageous to limit the use of high-Ts tackifier resin to a prescribed amount or less.

### (Polyacrylic Acid)

In some embodiments, the PSA layer may include a polyacrylic acid. For instance, when a water-dispersed acrylic PSA composition includes a suitable amount of a polyacrylic acid having a suitable number average molecular weight, the water resistance of the PSA layer formed from the water-dispersed PSA composition can be increased.

The molecular weight of the polyacrylic acid is not particularly limited. For instance, it is possible to use a polyacrylic acid having a number average molecular weight (Mn) of 2000 or higher and 550×10⁴ or lower. In some preferable embodiments, the polyacrylic acid can have a Mn of 3000 or higher and 500×10⁴ or lower, or 5000 or higher and 500×10⁴ or lower. With increasing Mn, the water resistance-enhancing effect tends to be more readily obtained. From such a standpoint, the polyacrylic acid's Mn is preferably 1×10⁴ or higher (e.g., 5×10⁴ or higher), more preferably 10×10⁴ or higher, yet more preferably 15×10⁴ or higher, or possibly 20×10⁴ or higher. On the other hand, when the polyacrylic acid has an excessively high Mn, addition of the polyacrylic acid may cause a drastic increase in viscosity of the PSA composition (specifically, a water-dispersed PSA composition), likely leading to problems such as lower applicability (harder application) and making it difficult to have a polyacrylic acid content suited for water resistance enhancement. From such a standpoint, the polyacrylic acid's Mn is preferably 400×10⁴ or lower, more preferably 300×10⁴ or lower, or yet more preferably 200×10⁴ or lower. In an embodiment of the art disclosed herein, the polyacrylic acid's Mn can be 150×10⁴ or lower, 100×10⁴ or lower, 75×10⁴ or lower, 50×10⁴ or lower, or even 35×10⁴ or lower.

As used herein, the number average molecular weight (Mn) refers to a value determined by GPC based on standard polyethylene glycols/polyethylene oxides.

In an embodiment using a polyacrylic acid, the amount of the polyacrylic acid can be set to favorably bring about the effect of its addition. In some embodiments, for every 100 parts by weight of base polymer, a polyacrylic acid is used in an amount of 0.3 part by weight or greater and 7 parts by weight or less. The polyacrylic acid content per 100 parts by weight of base polymer is more preferably 0.4 part by weight or greater, or yet more preferably 0.5 part by weight or greater. In some embodiments, the polyacrylic acid content per 100 parts by weight of base polymer can be 1 part by weight or greater, or even 1.5 part by weight or greater. In view of applicability and forming a PSA layer with good surface conditions, the polyacrylic acid content per 100 parts by weight of base polymer is more preferably 6 parts by weight or less, or yet more preferably 5 parts by weight or less (e.g., 4.5 parts by weight or less). In an embodiment of the art disclosed herein, the polyacrylic acid content per 100 parts by weight of base polymer can be 4.25 parts by weight or less, or even 4 parts by weight or less.

### (Crosslinking Agent)

The PSA composition used for forming the PSA layer may include a crosslinking agent as an optional component. The PSA layer in the art disclosed herein may comprise the crosslinking agent in a post-crosslinking-reaction form, in a pre-crosslinking-reaction form, in a partially crosslinked form, in an intermediate or combined form of these, etc. In typical, the crosslinking agent is included in the PSA layer mostly in the post-crosslinking-reaction form.

The type of crosslinking agent is not particularly limited. A suitable species can be selected and used among, for instance, isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, hydrazine-based crosslinking agents and amine-based crosslinking agents. Either an oil-soluble crosslinking agent or a water-soluble crosslinking agent may be used here as the crosslinking agent. For the crosslinking agent, solely one species or a combination of two or more species can be used. The amount of the crosslinking agent used is not particularly limited. For instance, to 100 parts by weight of base polymer (e.g., acrylic polymer), it is suitably about 10 parts by weight or less (e.g., about 0.005 part to 10 parts by weight) or preferably about 5 parts by weight or less (0.01 part to 5 parts by weight). The art disclosed herein can be preferably implemented in an embodiment using a PSA composition free of a crosslinking agent.

### (Other Additives)

From the standpoint of easy separation from release liner, the PSA layer may include a silicon compound (typically a silane coupling agent). For the silicon compound, one, two or more species can be used among alkylalkoxysilanes, vinyl group-containing silanes, epoxy group-containing silanes, styryl group-containing silanes, (meth)acryloyl group-containing silanes, amino group-containing silanes, ureido group-containing silanes, mercapto group-containing silanes, isocyanate group-containing silanes, silyl group-containing sulfides and the like. Among them alkylalkoxysilanes are preferable. The molecular weight of the silicon compound may be suitably about 100 or larger (e.g., 200 or larger). It can be about 500 or smaller (e.g., 350 or smaller).

As the alkylalkoxysilane, any of an alkyltrialkoxysilane, dialkyldialkoxysilane, trialkylmonoalkoxysilane, tetraalkoxysilane and phenylalkoxysilane can be used. The alkyl group can be either acyclic or cyclic. Specific examples of the alkylalkoxysilane include methyltrimethoxysilane, ethyltrimethoxysilane, n-propyltrimethoxysilane, n-butyltrimethoxysilane, isobutyltrimethoxysilane, n-hexyltrimethoxysilane, n-octyltrimethoxysilane, n-decyltrimethoxysilane, hexadecyltrimethoxysilane, methyltriethoxysilane, dimethoxydimethylsilane, diethoxydimethylsilane, cyclohexylmethyldimethoxysilane, methoxytrimethylsilane, octadecyldimethylmethoxysilane, phenyltrimethoxysilane, phenyltriethoxysilane, dimethoxydiphenylsilane, diphenylethoxymethylsilane, and dimethoxymethylphenylsilane. In particular, alkyltrialkoxysilanes are preferable.

From the standpoint of obtaining sufficient effects of its addition, the silicon compound content is preferably 0.005 part by weight or greater (e.g., 0.01 part by weight or greater, typically 0.03 part by weight or greater) relative to 100 parts by weight of base polymer (e.g., acrylic polymer). From the standpoint of the storage stability, the silicon compound content is preferably less than 1.0 part by weight (e.g., 0.5 part by weight or less, typically 0.3 part by weight or less) relative to 100 parts by weight of base polymer.

If necessary, the PSA composition disclosed herein may comprise an acid or base (ammonia water, etc.) used for such purposes as pH adjustment. Examples of other optional ingredients that may be added in the PSA composition disclosed herein include viscosity modifier, leveling agent, crosslinking-aiding agent, release modifier, plasticizer, softener, filler, colorant (pigment, dye, etc.), antistatic agent, anti-aging agent, UV-ray absorber, antioxidant and light stabilizer. With respect to these various additives, heretofore known species can be used by typical methods. Since these do not particularly characterize the present invention, further details are omitted.

### (Psa Composition)

The PSA layer disclosed herein can be formed from an aqueous PSA composition, solvent-based PSA composition, hot-melt PSA composition, or active energy ray-curable PSA composition which cures upon irradiation of active energy rays such as UV rays and electron beam. The aqueous PSA composition refers to a PSA composition that comprises a PSA (PSA layer-forming components) in a medium (aqueous medium) whose primary component is water, typically including a so-called water-dispersed PSA composition (in which the PSA is at least partially dispersed in an aqueous medium). The aqueous medium here refers to water, or a solvent mixture or dispersion medium (aqueous solvent or aqueous dispersion medium) whose primary component is water. The solvent-based PSA composition refers to a PSA composition that comprises a PSA in an organic solvent. As the organic solvent in the solvent-based PSA composition, among the examples (toluene, ethyl acetate, etc.) of the organic solvent possibly used in the solution polymerization, one, two or more species can be used without particular limitations. The art disclosed herein can be preferably implemented in an embodiment having a PSA layer formed from a water-dispersed (typically aqueous emulsion-based) PSA composition with adhesive components dispersed in an aqueous medium. For instance, in an emulsion-based acrylic PSA composition comprising a water-dispersed acrylic polymer, the water-dispersed acrylic polymer is typically designed to have a high molecular weight and tends to help obtain good processability.

(Formation of PSA layer) The PSA layer in the art disclosed herein may be preferably formed by providing a PSA composition such as the one described above to a given surface followed by drying or curing. When providing (typically applying) the PSA composition, a conventional coater can be used, such as gravure roll coater, reverse roll coater, kiss roll coater, dip roll coater, bar coater, knife coater and spray coater.

### (PSA Layer Thickness)

The PSA layer thickness can be set so that the double-faced PSA sheet has a total thickness of 60 μm or less of which the middle layer accounts for 10% to 60%. The first and second PSA layers may have the same thickness or different thicknesses. In typical, the first and second PSA layers independently have a thickness of suitably about 2 μm or greater. In view of impact resistance and adhesive properties such as adhesive strength and repulsion resistance, the PSA layer thickness is preferably about 5 μm or greater, more preferably 8 μm or greater, yet more preferably 10 μm or greater, or possibly 15 μm or greater (e.g., 18 μm or greater). In typical, the first and second PSA layers independently have a thickness of about 27 μm or less, suitably 25 μm or less, preferably about 20 μm or less, more preferably 16 μm or less, yet more preferably 14 μm or less, or particularly preferably 12 μm or less. PSA layers with limited thicknesses can effectively meet the demand for thinner and lighter products.

### <Middle Layer>

The double-faced PSA sheet disclosed herein has a middle layer having a Young's modulus in the range of 1.5 MPa to 1500 MPa. By using a middle layer with such a Young's modulus, in the double-faced PSA sheet thinly made with a total thickness of 60 μm or less, processability and impact resistance can be preferably combined. The middle layer can have a Young's modulus of 1000 MPa or lower, 500 MPa or lower, 300 MPa or lower, 100 MPa or lower (e.g., 95 MPa or lower), or 50 MPa or lower. Among the viscoelastic and mechanical properties, the impact resistance concerned by the art disclosed herein shows a relatively high correlation with the Young's modulus of the middle layer. When the Young's modulus of the middle layer is at or below an abovementioned maximum value, the impact resistance tends to increase. The PSA layer's anchoring power tends to also increase. In some embodiments, the middle layer has a Young's modulus of below 100 MPa, preferably below 50 MPa, more preferably 30 MPa or lower, yet more preferably 25 MPa or lower, possibly 20 MPa or lower, 15 MPa or lower, 10 MPa or lower, or 5 MPa or lower (e.g., below 5 MPa). In view of processability, the middle layer can have a Young's modulus of 3 MPa or higher, 8 MPa or higher, 12 MPa or higher, or 15 MPa or higher. In some embodiments, the middle layer has a Young's modulus of 30 MPa or higher, possibly 50 MPa or higher, 75 MPa or higher, 150 MPa or higher, 400 MPa or higher, or 800 MPa or higher. Specifically, the Young's modulus of the middle layer is determined by the method described later in Examples.

While no particular limitations are imposed, in some embodiments, the middle layer has a storage modulus at a frequency of 160 Hz (or a 160 Hz storage modulus) in the range of 7.0×10⁶ Pa to 5.0×10⁹ Pa. The frequency of 160 Hz is thought to correspond to the speed range during punching. An increase in 160 Hz storage modulus tends to help obtain good processability (specifically, ease of punching). From such a viewpoint, the 160 Hz storage modulus is suitably 1.8×10⁷ Pa or higher, preferably 5.0×10⁷ Pa or higher, more preferably 8.0×10⁷ Pa or higher, possibly 1.0×10⁸ Pa or higher, or 3.0×10⁸ Pa or higher. The maximum 160 Hz storage modulus can be, for instance, 3.0×10⁹ Pa or lower, 1.0×10⁹ Pa or lower, 5.0×10⁸ Pa or lower, 1.0×10⁸ Pa or lower, 5.0×10⁷ Pa or lower, or 1.0×10⁷ Pa or lower.

While no particular limitations are imposed, in some embodiments, the middle layer has a storage modulus at a frequency of 1000 Hz to 10000 Hz (or a 10³-10⁴ Hz storage modulus) of 3.7×10⁹ Pa or lower. This frequency range is thought to correspond to the speed range of impact (e.g., drop impact such as the impact in the impact resistance test described later). An increase in 10³-10⁴ Hz storage modulus tends to help obtain good impact resistance. From such a viewpoint, the 10³-10⁴ Hz storage modulus is preferably 1.0×10′ Pa or lower, more preferably 5.0×10⁸ Pa or lower, yet more preferably 3.0×10⁸ Pa or lower, possibly 1.0×10⁸ Pa or lower, or 1.0×10⁷ Pa or lower. The minimum 10³-10⁴ Hz storage modulus can be, for instance, 1.0×10⁶ Pa or higher, 5.0×10⁶ Pa or higher, 1.0×10⁷ Pa or higher, 5.0×10⁷ Pa or higher, 1.0×10⁸ Pa or higher, 5.0×10⁸ Pa or higher, or 1.0×10⁷ Pa or higher.

The storage moduli at the respective frequencies (at 160 Hz and at 10³ Hz to 10⁴ Hz) refer to values at 25° C. (reference temperature) and are, in particular, determined by the methods described later in Examples.

The middle layer disclosed herein is formed from a water-dispersed material. As used herein, the water-dispersed material refers to a material in which at least part of the middle-layer-forming material (e.g., polymer, filler, etc.) are dispersed in an aqueous medium. The aqueous medium refers to water or to a solvent mixture or dispersion medium (aqueous solvent or aqueous dispersion medium) whose primary component is water. A typical example of the water-dispersed material is a water dispersion of the middle-layer-forming material including the polymer. By using a water-dispersed material as the middle-layer-forming material, it is possible to prevent or reduce migration of components that may occur at the interfaces with the PSA layers. The fact that there is little interlayer component migration means that the PSA sheet is less susceptible to property changes with aging caused by the component migration. In a thin PSA sheet such as one disclosed herein, even a little migration of components can have a large effect on various properties such as adhesive properties. Thus, it is of practical importance to prevent or reduce interlayer component migration.

The water-dispersed material may include an emulsifier (surfactant) for the dispersibility, stability and so on of the material, or may be essentially free of emulsifiers. Here, the water-dispersed material being essentially free of emulsifiers means that no emulsifiers are intentionally used. For instance, the emulsifier content of the water-dispersed material is below 0.1 wt % (e.g., below 0.01 wt %, below 0.001 wt %) based on the solid content. For instance, in a water-dispersed resin such as the undermentioned water-dispersed polyurethane-based resin, so-called self-emulsifying and soap-free materials are typical examples of emulsifier-free water-dispersed materials.

As the material forming the middle layer, various resin materials capable of realizing an aforementioned Young's modulus can be used. For instance, a preferable middle layer is formed of a resin layer (resin film). As the resin film used for the middle layer, a non-foamed resin film and a rubber-like film are preferable. In view of processability, a non-foamed resin film is more preferable. As used herein, the “resin film” is an essentially nonporous film and is conceptually distinct from the so-called nonwoven fabric and woven fabric (i.e., nonwoven and woven fabrics are conceptually excluded). The term non-foamed resin film refers to a resin film that has not been subjected to an intentional treatment to make a foam. In particular, the non-foamed resin film can be a resin film having an expansion ratio below 1.1 (e.g., below 1.05, typically below 1.01).

Examples of the middle-layer-forming resin material include polyurethane-based resins; polyolefinic resins; acrylic resins such as acrylic copolymers; vinyl chloride-based resins (PVC) such as soft polyvinyl chloride; silicone such as silicone rubber; blends and hybrids (also called composites) of these resins. Examples of hybrids of these resins include urethane-acrylic hybrids and silicone-urethane hybrids. The middle-layer-forming material can be rubber (including those generally called rubber and thermoplastic elastomers). By selecting and using suitable one, two or more species among these materials, it is possible to obtain a middle layer having the aimed Young's modulus. In some embodiments, as the resin material in the middle layer, a polyurethane-based resin, polyolefinic resin, rubber, acrylic resin, or a blend of these (e.g., acrylic urethane resin) is used. By selecting a suitable species among these materials, processability and impact resistance can be preferably combined. In particular, polyurethane-based resins and acrylic urethane resins are preferable.

In some preferable embodiments, the middle layer includes a polyurethane-based resin (in particular, a water-dispersed polyurethane-based resin). By selecting and using suitable one, two or more species of polyurethane resins, it is possible to preferably obtain a middle layer having the aimed Young's modulus. For instance, in an embodiment laminated with an acrylic PSA layer, the polyurethane-based resin-containing middle layer helps obtain good anchoring and anchor failure is less likely to occur upon impact, helping to obtain excellent impact resistance. Here, the polyurethane-based resin refers to a polymer synthesized by allowing a polyol (e.g., diol) and a polyisocyanate (e.g., diisocyanate) to undergo polyaddition reaction at a suitable ratio. The polyol is not particularly limited. Suitable one, two or more species are selected and used among various diols, polyester polyols, polyether polyols, carbonate diols, etc. The polyisocyanate is not particularly limited. Suitable one, two or more species are selected and used among aromatic, aliphatic and alicyclic diisocyanates, multimers (e.g., dimers, trimers) of these diisocyanates, etc. In the synthesis of the polyurethane-based resin, the NCO/OH ratio is suitably set to obtain desirable mechanical properties. In the polyurethane-based resin, in addition to the polyol and polyisocyanate, other comonomer(s) (e.g., a carboxylic acid) may be introduced. The amount of the other comonomer suitably accounts for about less than 10 wt % (e.g., 0 wt % to 3 wt %) of the polyurethane-based resin. As the polyurethane-based resin, any can be used among ether-based polyurethanes, ester-based polyurethanes and carbonate-based polyurethanes. Especially, ester-based polyurethanes are preferable.

In some embodiments, the polyurethane-based resin in the middle layer can be an acrylic urethane-based resin. Examples of the acrylic urethane-based resin include a reaction product of an isocyanate-based compound and an acrylic polymer having two or more hydroxy groups (specifically, a polyol-based acrylic copolymer), and a copolymer of an alkyl (meth)acrylate and a urethane prepolymer having ethylenically unsaturated groups at both terminals. The acrylic urethane-based resin can be a urethane-acrylic hybrid. Examples of the urethane-acrylic hybrid include a water-dispersed urethane-acrylic hybrid obtainable by seeded polymerization of a (meta)acrylic monomer, using the urethane prepolymer in a water dispersion of urethane prepolymer as seeds.

In other embodiments, the middle layer is formed of a resin comprising a urethane (meth)acrylate-based polymer as a polyurethane-based resin. As the urethane (meth)acrylate-based polymer disclosed herein, a polymer comprising a structural moiety derived from a urethane (meth)acrylate can be used. Here, the urethane (meth)acrylate refers to a compound having a urethane bond and a (meth)acryloyl group in one molecule and such a compound can be used without particular limitations. For the urethane (meth)acrylate, solely one species or a combination of two or more species can be used. Urethane (meth)acrylate-based polymers can be synthesized by known methods. As the urethane (meth)acrylate, various commercially-available urethane (meth)acrylates can be used.

The polyurethane-based resin may be synthesized by a known method and molded into a film for use, or a commercially-available product can be obtained and used. Examples of the commercially-available products include product name UCOAT DA-100 available from Sanyo Chemical Industries, Ltd.; the ADEKA BONTIGHTER HUX series available fromADEKA Corporation; and the SUPERFLEX series available from DKS Co., Ltd.

In other embodiments, the middle layer may include a polyolefinic resin (specifically, a water-dispersed polyolefinic resin). By selecting and using suitable one, two or more species of polyolefinic resins, it is possible to obtain a middle layer having the aimed Young's modulus. Examples of the polyolefinic resin include an α-olefin homopolymer, a copolymer of two or more species of α-olefin, and a copolymer of one, two or more species of α-olefin and another vinyl monomer. Specific examples include polyethylene (PE), polypropylene (PP), poly-1-butene, poly-4-methyl-1-pentene, ethylene-propylene copolymers such as ethylene-propylene rubber (EPR), ethylene-propylene-butene copolymers, ethylene-butene copolymers, ethylene-vinyl alcohol copolymers and ethylene-ethyl acrylate copolymers. Either a low-density (LD) polyolefin or a high-density (HD) polyolefin can be used. Examples of commercially-available polyolefinic resins include the CHEMIPEARL series available from Mitsui Chemicals, Inc.

In other embodiments, the middle layer may include a rubber (specifically, a water-dispersed rubber which is also called latex). By selecting and using one, two or more species of rubbers, the resulting middle layer can have the aimed Young's modulus. Examples of rubbers include styrene-butadiene copolymer, styrene-isoprene copolymer, styrene-ethylene-butylene copolymer, styrene-ethylene-propylene copolymer, styrene-butadiene-styrene copolymer, styrene-isoprene-styrene copolymer, and their modification products (i.e., styrene-based copolymer (typically styrene-based elastomer)). Examples of commercially-available rubbers include the NIPOL series available from Zeon Corporation.

In other embodiments, the middle layer may include an acrylic resin (specifically, a water-dispersed acrylic resin). The acrylic polymer serving as the acrylic resin may be a homopolymer or a copolymer (random copolymer, block copolymer, graft copolymer, etc.). The acrylic resin encompasses a so-called acrylic rubber. The acrylic resin is preferably used as a blend or hybrid with a polyurethane-based resin. As the acrylic resin, a species having properties suited as the middle layer material can be used without particular limitations. For instance, it can be synthesized by a known or commonly-used method, or a commercial-available product can also be used.

In other embodiments, the middle layer may include silicone. The silicone encompasses a silicone rubber. It is preferable to use the silicone as a blend or hybrid with a polyurethane-based resin. As the silicone, it is possible to use a species synthesized by a known method or a commercial-available product. Examples of commercially-available silicone-urethane hybrid resins include product name CHALINE RU-911 available from Nissin Chemical Industry Co., Ltd.

In some embodiments, the middle layer may include filler particles in addition to the various resins. The use of filler particles increases the Young's modulus of the middle layer, helping to obtain superior processability. As the filler particles, both organic and inorganic materials can be used. Preferable examples include inorganic materials such as metal filler particles, metal oxide fillers such as silica, metal hydroxide filler particles, and carbonate salts such as calcium carbonate. As the filler particles, solely one species or a combination of two or more species can be used. In view of dispersibility with resin, the filler particles are preferably added as a dispersion. The particle diameters of filler particles are not particularly limited. Suitably-sized filler particles can be used in accordance with the thickness of the middle layer to which they are added, dispersibility, etc.

In embodiments where the middle layer includes filler particles, the amount thereof is not particularly limited. For effective addition of filler particles, the amount of filler particles mixed per 100 parts by weight of resins in the middle layer is, for instance, 1 part by weight or greater, suitably 10 parts by weight or greater, possibly 20 parts by weight or greater, or 30 parts by weight or greater. The maximum amount of filler particles per 100 parts by weight of resins is, for instance, less than 100 parts by weight, or suitably about 70 parts by weight or less. In other embodiments, the amount of filler particles in the middle layer per 100 parts by weight of resins included therein is, for instance, less than 30 parts by weight, possibly less than 10 parts by weight, or even less than 1 part by weight. The middle layer disclosed herein can be essentially free of filler particles.

The middle layer may include various additives as necessary, such as leveling agent, thickener, anti-aging agent, antioxidant, ultraviolet absorber, antistatic agent, lubricant, plasticizer, colorant (pigment, dye, e.g., carbon black) and preservative. A known or conventional surface treatment, such as corona discharge treatment, plasma treatment and primer coating, may be applied to the middle layer surface (in particular, the surface on the side to which the PSA layer is provided). Such surface treatment may be, for example, treatment to increase the anchoring of the PSA layer to the substrate. It is noted that when the middle layer includes a polyurethane-based resin, because of the resin's high surface energy, good anchoring can be obtained without an aforementioned surface treatment.

The middle layer may have a monolayer structure or a multilayer structure formed of two, three or more layers. For instance, the middle layer may be substantially formed of a layer of an aforementioned resin. The middle layer may include a secondary layer in addition to the resin layer.

As the method for producing the middle layer, a heretofore known film formation method can be suitably employed with no particular limitations. When using a resin film as the middle layer, for instance, heretofore known general film formation methods can be suitably employed, such as extrusion molding, inflation molding, T-die casting and calendar rolling. The middle layer can also be favorably formed by applying a middle-layer-forming material (e.g., an aqueous resin dispersion) onto a certain surface (e.g., a releasable surface) and allowing it to cure by means of drying, etc.

The middle layer thickness is set to account for at least 10% and up to 60% of the total thickness of the double-faced PSA sheet. This preferably brings about both processability and impact resistance in the thin double-faced PSA sheet. The thickness proportion of the middle layer can be 55% or lower, or 50% or lower. In some preferable embodiments, in view of impact resistance, the thickness proportion of the middle layer is below 50%, more preferably 45% or lower, yet more preferably 40% or lower, or particularly preferably 35% or lower, or possibly 30% or lower. When the middle layer is set to have a relatively low thickness proportion, adhesive properties such as adhesive strength and repulsion resistance tend to increase. In other preferable embodiments, the thickness proportion of the middle layer can be 25% or lower, or 20% or lower (e.g., 15% or lower). In such an embodiment with the middle layer having a small thickness proportion, the effect of the art disclosed herein can be favorably obtained. In some preferable embodiments, in view of the productivity and handling properties, the minimum thickness proportion of the middle layer can be 15% or higher, 20% or higher, 25% or higher (e.g., above 25%), 26% or higher, 27% or higher, or even 30% or higher (e.g., above 30%). In other embodiments, the thickness proportion of the middle layer can be 35% or higher, 40% or higher, or 45% or higher.

Specifically, the middle layer has a thickness of, for instance, about 1 μm or greater, typically 3 μm or greater, preferably 5 μm or greater, more preferably 7 μm or greater, or yet more preferably 9 μm or greater. According to the art disclosed herein, with the middle layer having at least a certain thickness, excellent impact resistance can be realized while obtaining good processability, handling properties, etc. From such a viewpoint, the middle layer thickness can be 10 μm or greater, 15 μm or greater, 18 μm or greater, or 22 μm or greater. The maximum middle layer thickness is about 36 μm or less, preferably 30 μm or less, more preferably 25 μm or less, yet more preferably 20 μm or less, particularly preferably 15 μm or less, or possibly 12 μm or less. By limiting the middle layer thickness, the impact resistance tends to increase. The middle layer with a limited thickness can effectively meet the demand for thinner and lighter products.

### <Release Liner>

The release liner protecting and/or supporting the PSA layer is not particularly limited material-wise or construction-wise. A suitable release liner may be selected and used among known release liners. For example, a preferable release liner has at least one surface that has been subjected to release treatment (typically, a surface provided with a release layer made of a release agent). As the substrate constituting this type of release liner (i.e. the substrate to be subjected to release treatment), a suitable substrate can be selected and used among substrates similar to those listed above as the substrate constituting the PSA sheet (e.g., various types of plastic film, paper, fabric, rubber sheet, foam sheet, metal foil, and composites thereof). As the release agent forming the release layer, a known or conventional release agent (e.g., silicone-based, fluorine-based, and long-chain alkyl-type release agents) can be used. Alternatively, a low-adhesion substrate formed of a fluorine-based polymer (e.g., polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer) or a low-polarity polymer (e.g., olefin resins such as polyethylene and polypropylene) may be used as the release liner without applying any particular release treatment to the substrate surface. Such a low-polarity substrate can also be used as the release liner after release treatment to the surface.

The thicknesses of the substrate and the release layer constituting the release liner are not particularly limited and may be suitably selected according to the intended purpose and other considerations. The overall thickness of the release liner (in a release liner having a release layer on the substrate surface, the overall thickness including the substrate and the release layer) is, for instance, preferably at least 15 μm (typically about 15 μm to 500 μm), or more preferably about 25 μm to 500 μm.

### <Method for Producing Double-Faced PSA Sheet>

In preparing a double-faced PSA sheet, the method is not particularly limited in providing a PSA layer to each of the first and second faces of the middle layer. To each of the first and second faces, usually, any method can be preferably applied, selected from the following: (1) a transfer method where the PSA composition is provided (typically applied) to a release liner and dried to form a PSA layer on the release liner, and then the PSA layer is adhered and transferred (layered) onto the middle layer; (2) a direct method (direct-coating method) where the PSA composition is directly provided (typically applied) to the middle layer and dried. For example, a double-faced PSA sheet can be produced by applying the transfer method to each face of the middle layer (transfer/transfer method), or a double-faced PSA sheet can be produced by applying the transfer method to one face (typically the face provided with the first PSA layer) of the middle layer and the direct method to the other side (transfer/direct method). Alternatively, (3) a simultaneous coating method can be employed to produce a double-faced PSA sheet having a first PSA layer, a middle layer and a second PSA layer in this order; in this method, a first PSA composition (e.g., a first PSA-layer-forming composition) is applied to a release liner; a middle-layer-forming material (e.g., a water dispersion of resin) is applied thereatop; a second PSA composition (e.g., a second PSA-layer-forming PSA composition) is further applied thereatop; and the resultant is dried or cured as a whole. According to this method, the curing process such as drying can be performed only once on the entire product, which is advantageous in terms of productivity. The art disclosed herein uses a water-dispersed material as the middle-layer-forming material, and thus is less likely to cause the occurrence of mixed layers (regions where components of one layer penetrate into another layer) among the respective layers, enabling production of PSA sheets by simultaneous coating with continuous application of the materials forming the first PSA layer, middle layer, and second PSA layer. As for the simultaneous coating method and conditions, choices can be made among various methods and conditions unsusceptible to interlayer mixing.

### <Properties of Double-Faced PSA Sheet>

While no particular limitations are imposed, like the middle layer, the double-faced PSA sheet may have a Young's modulus in the range of 1.5 MPa to 1500 MPa. Here, as described later in Examples, the Young's modulus of the double-faced PSA sheet is a Young's modulus converted per cross-sectional area of the middle layer, and is roughly equal to the Young's modulus of the middle layer. Thus, the middle layer's Young's modulus can be estimated from the double-faced PSA sheet's Young's modulus converted per cross-sectional area of the middle layer. The double-faced PSA sheet can have a Young's modulus of 1000 MPa or lower, 500 MPa or lower, 300 MPa or lower, 100 MPa or lower, or 50 MPa or lower. With the Young's modulus of the double-faced PSA sheet at or below an aforementioned maximum value, the impact resistance tends to increase. In some embodiments, the double-faced PSA sheet has a Young's modulus of below 100 MPa, preferably below 50 MPa, more preferably 30 MPa or lower, yet more preferably 25 MPa or lower, possibly 20 MPa or lower, 15 MPa or lower, 10 MPa or lower, or even 5 MPa or lower (e.g., below 5 MPa). In view of the processability, the double-faced PSA sheet can have a Young's modulus of 3 MPa or higher, possibly 8 MPa or higher, 12 MPa or higher, or 15 MPa or higher. In some embodiments, the double-faced PSA sheet has a Young's modulus of 30 MPa or higher, possibly 50 MPa or higher, 75 MPa or higher, 150 MPa or higher, 400 MPa or higher, or even 800 MPa or higher. Specifically, the Young's modulus of the double-faced PSA sheet is determined by the method described later in Examples.

The adhesive strength of the double-faced PSA sheet disclosed herein is not particularly limited. In some embodiments, the double-faced PSA sheet may have a 180° peel strength of, for instance, 5 N/20 mm or greater after applied to a stainless-steel plate and maintained at 23° C. and 50% RH for 30 minutes (on-SUS peel strength). The double-faced PSA sheet showing such a property is preferably used as an adhesively high-strength double-faced PSA sheet to securely fix objects and parts. The on-SUS peel strength is preferably 6 N/20 mm or greater, or possibly 7 N/20 mm or greater. In some preferable embodiments, the on-SUS peel strength is 8 N/20 mm or greater, more preferably 10 N/20 mm or greater, yet more preferably 12 N/20 mm or greater, or particularly preferably 14 N/20 mm or greater, or possibly 16 N/20 mm or greater. The maximum on-SUS peel strength is not particularly limited. It can be about 30 N/20 mm or less (e.g., 25 N/20 mm or less). Specifically, the on-SUS peel strength can be determined by the method described later in Examples. In the double-faced PSA sheet having adhesive faces on both sides, the two faces can have the same on-SUS peel strength or different values.

### <Applications>

The double-faced PSA sheet disclosed herein is thinly made, yet can realize both processability and impact resistance. With these characteristics, the double-faced PSA sheet can be preferably used for applications on various products that are desirably thin while requiring processability and impact resistance or components of these products, for purposes such as fixing, bonding, shaping, decorating, protecting and supporting the products or components. In particular, it can be preferably used for fixing the products or components. For instance, with respect to portable electronic devices, there is a strong demand for smaller and lighter products; and PSA sheets for portable electronic devices are desired to have small thicknesses. Portable electronic devices are at risk of falling due to the way they are used. PSA sheets used in portable electronic devices may need to have impact resistance. Furthermore, PSA sheets used to secure components of portable electronic devices are required to have good processability because they are subjected to a cutting process such as punching to fit the shapes of bonding/fixing areas, and are required to have good processability. The double-faced PSA sheet disclosed herein is suitable for such portable electronic devices.

Non-limiting examples of the mobile electronics include mobile phones, smartphones, tablet PCs, notebook PCs, various wearable devices (e.g., wrist wearables put on wrists such as wrist watches; modular devices attached to bodies with clips, straps, etc.; eye wears including eye glass types (monocular or binocular, including head-mounted pieces); clothing types worn as, for instance, accessories on shirts, socks, hats/caps, etc.; ear-mounted pieces put on ears such as earphones), digital cameras, digital video cameras, acoustic equipment (portable music players, IC recorders, etc.), calculators (e.g., pocket calculators), handheld game devices, electronic dictionaries, electronic notebooks, electronic books, vehicle navigation devices, portable radios, portable TVs, portable printers, portable scanners, and portable modems. In this description, to be “mobile (portable),” it is unsatisfactory to be simply capable of being carried. Instead, it indicates a level of mobility (portability) that allows for relatively easy carriage by hand of an individual (a typical adult).

The matters disclosed by this description include the following:
(1) A double-faced PSA sheet having a first PSA layer, at least one middle layer, and a second PSA layer in this order, wherein
   the double-faced PSA sheet has a total thickness of 60 μm or less,
   the middle layer has a thickness accounting for 10% to 60% of the total thickness,
   the middle layer is formed from a water-dispersed material, and
   the middle layer has a Young's modulus in the range of 1.5 MPa to 1500 MPa.
(2) The double-faced PSA sheet according to (1) above, wherein the middle layer has a storage modulus in the range of 7.0×10⁶ Pa to 5.0×10⁹ Pa at a temperature of 25° C. and at a frequency of 160 Hz.
(3) The double-faced PSA sheet according to (1) or (2) above, wherein the middle layer has a storage modulus of 3.7×10⁹ Pa or lower at a temperature of 25° C. and at a frequency of 1000 Hz to 10000 Hz.
(4) The double-faced PSA sheet according to any of(1) to (3) above, wherein the middle layer comprises a polyurethane-based resin, rubber, polyolefinic resin, acrylic resin, or a blend of these.
(5) The double-faced PSA sheet according to any of (1) to (4) above, wherein each of the first and second PSA layers is formed from a water-dispersed PSA composition.
(6) The double-faced PSA sheet according to any of (1) to (5) above, wherein each of the first and second PSA layers is an acrylic PSA layer comprising an acrylic polymer.
(7) The double-faced PSA sheet according to (6) above, wherein the acrylic polymer has a glass transition temperature (Tg) of −25° C. or lower.
(8) The double-faced PSA sheet according to any of (1) to (7) above, having a 180° peel strength on stainless-steel plate of 6 N/20 mm or greater.
(9) The double-faced PSA sheet according to any of (1) to (8) above, used for fixing a member in a portable electronic device.

### EXAMPLES

Several working examples relating to the present invention are described below, but the present invention is not intended to be limited to these examples. In the description below, “parts” and “%” are based on weight unless otherwise specified.

### Example 1

### (Preparation of Acrylic Polymer)

Into a reaction vessel equipped with a thermometer, stirrer, nitrogen inlet and reflux condenser, were added 0.07 part of a reactive surfactant (product name AQUALON KH-1025 available from DKS Co., Ltd.) and 61.1 parts of distilled water. While stirring, at 60° C., the resulting mixture was purged with nitrogen for one hour. Subsequently, to this, was added 0.10 part of a polymerization initiator (product name VA-057 available from FUJIFILM Wako Pure Chemical Corporation). To this, at 60° C., were added dropwise an emulsion (85 parts of 2-ethylhexyl acrylate (2EHA), 13 parts of methyl acrylate (MA), 1.25 parts of acrylic acid (AA), 0.75 part of methacrylic acid (MAA), 0.025 part oft-dodecanethiol (chain transfer agent), 0.02 part of 3-methacryloxypropyltrimethoxysilane (product name KBM-503 available from Shin-Etsu Chemical Co., Ltd.) and 1.93 parts of the reactive surfactant in 28 parts of distilled water) over 4 hours to carry out emulsion polymerization. After the reaction mixture was further maintained at 60° C. for 3 hours, 0.05 part of the polymerization initiator was added and the reaction mixture was further maintained at 60° C. for 2 hours. The system was allowed to cool to room temperature and adjusted to pH 7 using 10% ammonia water as a pH-adjusting agent. To this, was added 0.0072 part of a preservative (product name NEOSINTOL 2208 available from SC Environmental Science Co., Ltd.). In this manner, was prepared a water dispersion of acrylic polymer. The acrylic polymer had a solid concentration of 50.5% and a sol weight average molecular weight (Mw) of 34×10⁴.

### (Preparation of PSA Composition)

To the water dispersion of acrylic polymer, for every 100 parts of non-volatiles therein, were added 30 parts of a tackifier resin (polymerized rosin ester, product name SUPERESTER E-865NT available from Arakawa Chemical Industries, Ltd.; softening point 160° C.) and 3 parts of a polyacrylic acid (product name ALON A-10 available from Toagosei Co., Ltd.; number average molecular weight (Mn) 250000), and was further added 2 parts of a leveling agent (product name PELEX OT-P available from Kao Corporation). The resulting mixture was then adjusted to pH 8 with 10% ammonia water to prepare a PSA composition.

### (Formation of PSA Layers)

The resulting PSA composition was applied to a silicone-treated face of a 38 μm thick polyethylene terephthalate (PET) release liner (product name DIAFOIL RF38 available from Mitsubishi Chemical Corporation) to a dry thickness of 10 μm. The resultant was then heated and dried at 100° C. for 3 minutes to form a PSA layer on the release liner.

### (Formation of Middle Layer A)

To a water dispersion of polyurethane resin (polyester backbone) (product name UCOAT DA-100 available from Sanyo Chemical Industries, Ltd.), was added a thickener (product name ADEKANOL UH-541VF available from ADEKA Corporation) to a coating fluid viscosity of 3.0 Pa-s after addition. To this, was further added 1 part of a leveling agent (product name PELEX OT-P available from Kao Corporation). The resulting coating fluid was applied to a silicone-treated face of a 38 μm thick PET release liner (product name DIAFOIL MRF38 available from Mitsubishi Chemical Corporation) to a dry thickness of 10 μm. The resultant was then heated and dried at 100° C. for 3 minutes to form a middle layer A (middle layer film) according to this Example.

(Preparation of Double-Faced PSA Sheet) To one face of the middle layer A, was adhered the exposed face of the PSA layer. To the other face of the middle layer A upon release liner removal, was adhered a second PSA layer to obtain a laminate having a total thickness of 30 μm and a structure of the first PSA layer/middle layer A/second PSA layer. The laminate was autoclaved at 50° C. at 5 atm for 15 minutes and then aged in a dryer at 50° C. overnight to prepare a double-faced PSA sheet according to this Example.

### Examples 2 to 6

Changing the water-dispersed material used for forming the middle layer to the materials shown below, but otherwise in the same manner as Example 1, were prepared middle layers B to F. Using one of middle layers B to F as the middle layer, but otherwise in the same manner as Example 1, was obtained a double-faced PSA sheet according to each Example.
Middle layer B: water-dispersed polyurethane resin (ester backbone) (product name ADEKA BONTIGHTER HUX-380 available from ADEKA Corporation)
Middle layer C: water-dispersed polyurethane resin (aromatic isocyanate ester backbone) (product name SUPERFLEX 830HS available from DKS Co., Ltd)
Middle layer D: water-dispersed polyolefin resin (ionomer) (product name CfHEMIPEARL SA100M available from Mitsui Chemicals, Inc.)
Middle layer E: water-dispersed polyurethane resin (ether backbone) (product name ADEKA BONTIGHTER HUX-282 available from ADEKA Corporation)
Middle layer F: polyurethane/silica blend formed by adding and stir-mixing 40 parts (non-volatiles) of a water dispersion of silica particles (product name SNOWTEX ST-50T available from Nissan Chemical Corporation) to 100 parts of non-volatiles in a water-dispersed polyurethane resin (ester backbone) (product name ADEKA BONTIGHTER HUX-380 available from ADEKA Corporation)
Middle layer G: acrylic/urethane blend formed by mixing the PSA composition according to Example 1 and a water dispersion of polyurethane resin (polyester backbone) (product name UCOAT DA-100 available from Sanyo Chemical Industries, Ltd.) at a 2:1 non-volatile ratio

### Examples 7 to 10

The middle layer thickness and the total double-faced PSA sheet thickness were changed as shown in Table 1. Otherwise in the same manner as one of Examples 1 to 3, was obtained a double-faced PSA sheet according to each Example. In the double-faced PSA sheet according to each Example, the thickness of each PSA layer is (total thickness −middle layer thickness)×½.

### Examples 11 to 15

Changing the constitution of each double-faced PSA sheet as shown in Table 2, was obtained a double-faced PSA sheet according to each Example.

### <Evaluation>

### [Young's Modulus]

Among the middle layer materials, hard film-like self-standing samples were cut out to measure 10 mm in TD (transverse direction) and 50 mm in MD (machine direction). Soft non-self-standing samples with tack were cut out to measure 30 mm in MD and have a TD with a cross-sectional area (thickness×TD) of about 2.5 mm², and rolled into a rod along the TD to obtain samples, similar to general PSA testing methods. Each resulting sample was fixed in the chuck of a tensile testing machine with an effective measurement length of 10 mm. After 2 minutes in a measurement atmosphere at 23° C., a tensile test was carried out at a tensile speed of 50 mm/min to obtain a stress (vertical axis)-strain (horizontal axis) curve. From the resulting stress-strain curve, five points were selected in the infinitesimal deformation range (within 5% strain). From the slope obtained from the linear approximation formula, the Young's modulus (MPa) of the middle layer was determined. As the tensile testing machine, a precision universal tester, AUTOGRAPH AG-IS (available from Shimadzu Corporation) or a comparable product is used.

For the Young's modulus of a double-faced PSA sheet with middle layer, the Young's moduli of the PSA layers are much smaller than that of the middle layer; and therefore, the value per cross-sectional area of middle layer is used, rather than the cross-sectional area of the double-faced PSA sheet including the PSA layers.

### [Storage Modulus]

The middle layer or the PSA layer according to each Example was punched out to measure 10 mm in TD and 70 mm in MD to prepare a sample strip. Non-self-standing materials with tack were rolled into a cylindrical shape with a cross-sectional area of about 2.5 mm² to obtain samples. Each resulting sample was fixed in the chuck with an effective measurement jig length of 20 mm. Using a dynamic rheometer (model name RSA-G2 available from TA Instruments, Japan), dynamic viscoelastic measurement was carried out under the conditions shown below.

### (Measurement Conditions)

Measurement mode: tensile
Measurement frequency: 1 Hz
Temperature range: −40° C. to 30° C.
Heating rate: 5° C./min
measured in the elastic deformation range.

With respect to the frequency-dependent data at the respective temperatures, using the attached analytical software available from TA Instruments and setting the reference temperature to 25° C., the frequency-dependent data at the other temperatures were shifted to obtain frequency-dependent data of storage moduli (a so-called master curve in the polymer field).

From the resulting frequency-dependent storage modulus data, the storage moduli (Pa) were determined at the respective frequencies (160 Hz, 1000 Hz, and 10000 Hz) with the reference temperature at 25° C.

### [Peel Strength on SUS Plate]

The on-SUS peel strength of the PSA sheet of each Example was measured as follows: The release liner covering one face of the double-faced PSA sheet was removed and 25 μm thick polyethylene terephthalate (PET) film was adhered to back the PSA sheet. The backed PSA sheet was cut into 20 mm wide by 100 mm long in size to prepare a test piece. In an environment at 23° C. and 50% RH, the test piece was press-bonded with a 2 kg roller moved back and forth once to a stainless-steel plate (SUS304BA plate) as the adherend. The resultant was stored in the environment at 23° C. and 50% RH for 30 minutes. Based on JIS Z0237, using a tensile tester, the 180° peel strength (N/20 mm) was measured at a tensile speed of 300 mm/min. Three measurements (i.e., N=3) were taken and their average value was used as the on-SUS peel strength.

### [Impact Resistance]

Each double-faced PSA sheet with release-liner-protected adhesive faces was punched into a 24.5 mm square frame with 2 mm width to obtain a PSA sheet frame. A 2 mm thick, 50 mm square stainless-steel plate (SUS304BA) with a 20 mm square central hole, and also a 3 mm thick, 25 mm square stainless-steel plate (SUS304BA) were obtained. The PSA sheet frame with the release liners removed was placed between the two stainless-steel plates in a centrosymmetric arrangement (surrounding the hole of the holed stainless-steel plate) and press-bonded evenly at 62 N for 10 seconds. The resultant was left standing at 80° C. for 30 minutes and allowed to return to 23° C. overnight. This was used as a test piece. On the base of a DuPont impact tester (available from Toyo Seiki Seisaku-sho, Ltd.), a cylindrical die (50 mm long, 49 mm outer diameter, 43 mm inner diameter) was set and the test piece was placed thereatop in centrosymmetry about the center of the die with the square stainless-steel plate on the bottom. The test piece was arranged with the top holed stainless-steel plate supported on the die and the bottom square stainless-steel plate in the hollow part of the die, the bottom plate bonded via the PSA sheet frame with the holed stainless-steel plate. A stainless-steel impact punch (3.1 mm tip radius) was placed on the test piece (specifically, on top of the bottom square stainless-steel plate). At 23° C. and 50% RH, a weight was dropped onto the impact punch under the conditions (weight and drop height) shown below. In particular, the dropping weight and drop height were changed to increase the energy until peeling occurred, all in increments of 50 mm, from a drop height of 50 mm to 500 mm with a 50 g weight, from 300 mm to 500 mm with a 100 g weight, from 350 mm to 500 mm with a 150 g weight, from 400 mm to 500 mm with a 200 g weight, and from 350 mm to 500 mm with a 300 g weight. For this, the test was not performed at the energy at which measurement had already been taken, and the weight and height were set to avoid overlapping energy values. The integral of energy up to just before peeling was considered the impact absorption energy (J). The energy was calculated by multiplying the weight by the height. The measurement was performed three times (i.e., N=3), and the average value was used as the impact resistance test result.

### [Processability (Ease of Punching)]

From the release-linered double-faced PSA sheet (with both adhesive faces protected with two release liners) of each Example, were cut out five test piece strips (30 mm in TD, 150 mm in MD). Using a punch (product name HIGH-STRENGTH HOLE PUNCHER DP-110 (available from MAX Co., Ltd.), each test piece strip was successively punched 20 times along the MD. The number of successive complete punches was counted and evaluated by the following grades.

### (Number of Successive Complete Punches)

91 or more: E (excellent)
81 to 90: G (good)
71 to 80: F (fair)
70 or less: P (poor)

It is noted that before this test (processability test), for each release-linered double-faced PSA sheet, one release liner was exchanged from product name DIAFOIL MRF38 to product name DLAFOIL MHA25 (release liner available from Mitsubishi Chemical Corporation) and punching was performed on the DIAFOIL MHA25 side.

Tables 1 and 2 show the summary and test results of each Example.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Total PSA sheet thickness | | 30 | | | | | | 50 | | | 50 |
| (μm) | | | | | | | | | | | |
| Middle layer thickness (μm) | | 10 | | | | | | 12 | | | 25 |
| % middle layer thickness in | | 33% | | | | | | 24% | | | 50% |
| total thickness | | | | | | | | | | | |
| Middle | Type | A | B | C | D | E | F | B | C | A | A |
| layer | Material | Urethane | Urethane | Urethane | Polyolefin | Urethane | Urethane | Urethane | Urethane | Urethane | Urethane |
| | Young's modulus | 18.3 | 18.4 | 914.0 | 36.2 | 2.54 | 48.4 | 18.4 | 914.0 | 18.3 | 18.3 |
| | (Mpa) | | | | | | | | | | |
| | Storage modulus at | 7.5E+07 | 9.2E+07 | 3.0E+09 | 4.1E+08 | 7.5E+06 | 2.1E+08 | 9.2E+07 | 3.0E+09 | 7.5E+07 | 7.5E+07 |
| | 160 Hz (Pa) | | | | | | | | | | |
| | Storage modulus at | 8.2E+07 | 1.2E+08 | 3.1E+09 | 5.3E+08 | 8.3E+06 | 2.6E+08 | 1.2E+08 | 3.1E+09 | 8.2E+07 | 8.2E+07 |
| | 10³ Hz (Pa) | | | | | | | | | | |
| | Storage modulus at | 9.1E+07 | 1.7E+08 | 3.4E+09 | 6.8E+08 | 9.9E+06 | 3.6E+08 | 1.7E+08 | 3.4E+09 | 9.1E+07 | 9.1E+07 |
| | 10⁴ Hz (Pa) | | | | | | | | | | |

| | | | | | | | | | | |
|---|---|---|---|---|---|---|---|---|---|---|
| On-SUS adhesive strength | 11.6 | 14.9 | 10.0 | 9.0 | 8.3 | 10.9 | 17.7 | 14.9 | 16.4 | 13.6 |
| (N/20 mm) | | | | | | | | | | |
| Impact test (J) | 0.26 | 0.16 | 0.074 | 0.082 | 0.246 | 0.12 | 0.30 | 0.20 | 0.47 | 0.42 |
| Processability | E | E | E | E | E | E | E | E | E | E |

TABLE 2

| | | Ex. 11 | Ex. 12 | Ex. 13 | Ex. 14 | Ex. 15 |
|---|---|---|---|---|---|---|
| Total PSA sheet thickness (μm) | | 32 | 30 | 30 | 50 | 50 |
| Middle layer thickness (μm) | | 12 | — | 10 | 38 | — |
| % middle layer thickness in total thickness | | 37.5% | 0% | 33% | 76% | 0% |
| Middle | Type | PET | N/A | G | A | N/A |
| layer | Material | | | Acryl/urethane | Urethane | |
| | Young's modulus (Mpa) | 1560 | | 0.2 | 18.3 | |
| | Storage modulus at 160 Hz (Pa) | 5.6E+09 | | 6.4E+06 | 7.5E+07 | |
| | Storage modulus at 10³ Hz (Pa) | 5.6E+09 | | 1.1E+07 | 8.2E+07 | |
| | Storage modulus at 10⁴ Hz (Pa) | 5.9E+09 | | 1.9E+07 | 9.1E+07 | |

| | | | | | |
|---|---|---|---|---|---|
| On-SUS adhesive strength (N/20 mm) | 8.0 | 10.8 | — | 5.3 | 18.1 |
| Impact test (J) | 0.008 | 0.20 | — | 0.02 | 0.40 |
| Processability | E | P | P | E | P |

As shown in Tables 1 and 2, the double-faced PSA sheets according to Examples 1 to 10 having middle layers with Young's moduli between 1.5 MPa and 1500 MPa exhibited high impact resistance (≥0.1 J) and excellent processability. On the other hand, for Example 11 using a middle layer with Young's modulus >1500 MPa, the impact resistance was low at 0.008 J. Example 13 using a middle layer with Young's modulus <1.5 MPa failed the processability test. As for Example 14 using the same middle layer material as Example 1 and having a middle layer thickness accounting for 60% of the total thickness, the impact resistance was low at 0.02 J. With respect to the PSA sheets according to Examples 12 and 15 each consisting of a middle-layer-free PSA layers, with 0% middle layer thickness and the low Young's modulus of the PSA layer alone low at 0.06 MPa, they failed the processability test.

It is noted that the Young's moduli of the PSA sheets of Examples 1 and 3 were measured and determined to be in the range of 1.5 MPa to 1500 MPa, showing to have a certain correlation with the middle layer's Young's modulus.

The PSA sheets according to Examples 12 and 15 (consisting of a middle-layer-free PSA layer) had a Young's modulus of 0.06 MPa, a 160 Hz storage modulus of 2.9×10⁶ Pa, a 10³Hz storage modulus of 8.0×10⁶ Pa, and a 10⁴ Hz storage modulus of 6.0×10⁷ Pa.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1 PSA sheet
11 first PSA layer
11A first adhesive face
12 second PSA layer
12A second adhesive face
15 middle layer
21 release liner

1. A double-faced pressure-sensitive adhesive sheet comprising a first pressure-sensitive adhesive layer, at least one middle layer, and a second pressure-sensitive adhesive layer in this order, wherein
the double-faced pressure-sensitive adhesive sheet has a total thickness of 60 μm or less,
the middle layer has a thickness accounting for 10% to 60% of the total thickness,
the middle layer is formed from a water-dispersed material, and
the middle layer has a Young's modulus in the range of 1.5 MPa to 1500 MPa.

2. The double-faced pressure-sensitive adhesive sheet according to claim 1, wherein the middle layer has a storage modulus in the range of 7.0×10⁶ Pa to 5.0×10⁹ Pa at a temperature of 25° C. and at a frequency of 160 Hz.

3. The double-faced pressure-sensitive adhesive sheet according to claim 1, wherein the middle layer has a storage modulus of 3.7×10⁹ Pa or lower at a temperature of 25° C. and at a frequency of 1000 Hz to 10000 Hz.

4. The double-faced pressure-sensitive adhesive sheet according to claim 1, wherein the middle layer comprises a polyurethane-based resin, rubber, polyolefinic resin, acrylic resin, or a blend thereof.

5. The double-faced pressure-sensitive adhesive sheet according to claim 1, wherein each of the first and second pressure-sensitive adhesive layers is formed from a water-dispersed pressure-sensitive adhesive composition.

6. The double-faced pressure-sensitive adhesive sheet according to claim 1, wherein each of the first and second pressure-sensitive adhesive layers is an acrylic pressure-sensitive adhesive layer comprising an acrylic polymer.

7. The double-faced pressure-sensitive adhesive sheet according to claim 6, wherein the acrylic polymer has a glass transition temperature of −25° C. or lower.

8. The double-faced pressure-sensitive adhesive sheet according to claim 1, having a 1800 peel strength on stainless-steel plate of 6 N/20 mm or greater.

9. The double-faced pressure-sensitive adhesive sheet according to claim 1, in use for fixing a member in a portable electronic device.
